(19) United States
(12) Patent Application Publication
(10) Pub. No.: US 2025/0187586 A1
(43) Pub. Date: Jun. 12, 2025

(54) AN INTELLIGENT ADAPTIVE SPORT CONTROL

(71) Applicant: Volvo Car Corporation, Göteborg (SE)

(72) Inventors: Mikael Törmänen, Molndal (SE); Matthias Le Saux, Göteborg (SE); Jonas Carlsson, Mölndal (SE); Kristina Ek Blohm, Torslanda (SE)

(21) Appl. No.: 18/536,464

(22) Filed: Dec. 12, 2023

(51) Int. Cl. B60W 30/02; B60W 50/14

(52) U.S. Cl. CPC B60W 30/02; B60W 50/14; B60W 2530/20; B60W 2720/18

(57) ABSTRACT

Systems/techniques that facilitate an intelligent adaptive sport control of vehicle rolling resistance are provided. In various embodiments, a system can receives a sport mode level, receives a target location data and determines a first route based on target location data and the sport mode level, determines a first energy level required to use the sport mode on the first route, displays the first route and an indication that the sport mode is available to use based on the first energy level.

### TECHNICAL FIELD

The subject disclosure relates generally to artificial intelligence, and more specifically to artificially intelligent provision of vehicle rolling resistance systems.

### BACKGROUND

Rolling resistance is a force that opposes the motion of a vehicle's tires as they roll along the surface of a road. Reducing rolling resistance in vehicles is essential for determining vehicle performance and improving energy consumption. However, the methods employed to achieve this goal also have some shortcomings and limitations. Low rolling resistance tires are designed to minimize energy loss, but achieving this often involves trade-offs. These tires may offer reduced traction, shorter tread life, braking performance, ride comfort and compromised handling in certain conditions. For example, such trade-offs can prove dangerous on snowy or icy roads. Achieving a balance between low rolling resistance, safety, and driving performance can be challenging in current methods. Low rolling resistance tires may not be suitable for all vehicles or driving conditions, as rolling resistance is influenced by the road surface. Vehicles that regularly carry heavy loads, tow trailers, or frequently travel on rough terrain, for example, may not benefit as much from these tires. Rolling resistance can change as tires age and wear. Current methods may not account for these changes over time. Rolling resistance is influenced by numerous variables such as tire type, inflation pressure, temperature, and load. Current methods and systems often struggle to account for all of these variables simultaneously to minimize rolling resistance. Vehicle rolling resistance is not a static property, as it can change as the vehicle is in motion. Rolling resistance can depend upon the alignment of tires on the road due to the vehicle's chassis settings. Current methods often provide data after the fact and may not adequately capture these dynamic effects, making it challenging for drivers and systems to make real-time adjustments to reduce rolling resistance and improve energy efficiency.

Accordingly, systems or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate artificially intelligent provision of vehicle rolling resistance systems are described. According to an embodiment, a system, comprises: a processor that executes computer-executable components stored in a non-transitory computer-readable memory, the computer-executable components comprising: a drive mode component receives a sport mode level; a route determination component receives a target location data and determines a first route based on target location data and the sport mode level; an energy management component that determines a first energy level required to use the sport mode on the first route; and a user interface component that displays the first route and an indication that the sport mode is available to use based on the first energy level.

According to an embodiment, a computer-implemented method, comprises: receiving, by a system comprising a processor, a sport mode level; receiving, by the system, a target location data and determining a first route based on target location data and the sport mode level; determining, by the system, a first energy level required to use the sport mode on the first route; and displaying, by the system, the first route and an indication that the sport mode is available to use based on the first energy level.

According to yet another embodiment, non-transitory machine-readable medium, comprising executable instructions that, when executed by a processor, facilitate performance of operations, comprises: receiving a sport mode level and a target location data; determining a first route based on target location data and the sport mode level and determining a first energy level required to use the sport mode on the first route; and displaying the first route and an indication that the sport mode is available to use based on the first energy level.

According to one or more embodiments, the above-described systems can be implemented as computer-implemented methods or computer program products.

### DESCRIPTION OF THE DRAWINGS

FIG. 1A illustrates a block diagram of an example, non-limiting system that facilitates artificially intelligent provision of vehicle rolling resistance in accordance with one or more embodiments described herein.

FIG. 1B illustrates a block diagram of an example, non-limiting system that facilitates artificially intelligent provision of vehicle rolling resistance in accordance with one or more embodiments described herein.

FIG. 2 illustrates a block diagram of an example, non-limiting system that facilitates artificially intelligent provision of vehicle rolling resistance in accordance with one or more embodiments described herein.

FIG. 3 illustrates a block diagram of an example, non-limiting system that facilitates artificially intelligent provision of vehicle rolling resistance in accordance with one or more embodiments described herein.

FIG. 4 illustrates a block diagram of an example, non-limiting system that facilitates artificially intelligent provision of vehicle rolling resistance in accordance with one or more embodiments described herein.

FIG. 5 illustrates a block diagram of an example, non-limiting system that facilitates artificially intelligent provision of vehicle rolling resistance in accordance with one or more embodiments described herein.

FIG. 6 illustrates a block diagram of an example, non-limiting system that facilitates artificially intelligent provision of vehicle rolling resistance in accordance with one or more embodiments described herein.

FIG. 7 illustrates a flow diagram of an example, non-limiting computer-implemented method that facilitates artificially intelligent provision of vehicle rolling resistance in accordance with one or more embodiments described herein.

FIG. 8A illustrates a flow diagram of an example, non-limiting computer-implemented method that facilitates artificially intelligent provision of vehicle rolling resistance in accordance with one or more embodiments described herein.

FIG. 8B illustrates a flow diagram of an example, non-limiting computer-implemented method that facilitates artificially intelligent provision of vehicle rolling resistance in accordance with one or more embodiments described herein.

FIG. 9 illustrates a flow diagram of an example, non-limiting computer-implemented method that facilitates artificially intelligent provision of vehicle rolling resistance in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Rolling resistance in vehicles can be minimized through various methods. Applying low resistance tires that have specialized rubber compounds and tread patterns to a vehicle can enable a reduction in energy. Manually maintaining the recommended inflation pressure can also minimize tire deformation and energy loss.

Unfortunately, and as recognized by the inventors of various embodiments described herein, existing techniques for minimizing rolling resistance in vehicles can be unreliable for various reasons.

First, the present inventors realized that low resistance tires are not suitable for all driving conditions, compromising safety for energy efficiency in various situations. For example, tires optimized for rolling resistance often have shallow tread patterns. Although shallow tread patterns can reduce energy loss, it can also reduce the tire's grip or traction with the road. Reduced traction and compromised handling can pose danger in various situations (e.g., driving on rough terrain, sharp turns, steep grade roads, wet or icy roads, driving at high speeds). For example, reduced traction can prevent the tires from displacing water on wet roads, causing the risk of hydroplaning during heavy rain. As another example, low traction is not suitable for driving at fast speeds or taking sharp turns. Low resistance tires can risk skidding or loss of control in such situations, especially any wet or icy conditions. Furthermore, tires designed for reduced rolling resistance may require longer distances to come to a complete stop. Such extended braking distance can expose the driver or vehicle passengers to hazards in various situations (e.g., driving downhill, sudden pedestrian crossings, driving in rain or snow, unexpected animal crossings, abrupt stops from a vehicle directly ahead). Moreover, rolling resistance tires require proper tire inflation at all times to benefit and achieve fuel savings. However, maintenance of proper tire pressure requires manual inflation of the tires and manual monitoring of tire pressure on vehicles not equipped with a tire pressure monitoring system. Furthermore, low resistance tires have a low tread life compared to conventional tires. Low resistance tires experience wear and tear at a fast rate, potentially leading to frequent tire replacements.

Furthermore, the present inventors realized that conventional methods to reduce rolling resistance lack the ability to simultaneously consider multiple variables and factors. For example, equipping low rolling resistance tires to a vehicle can compromise the driver's chosen driving mode (e.g., sports mode, comfort mode, eco mode). In various instances, in high-performance or sport driving modes, such as aggressive cornering or high-speed maneuvers, low resistance tires may not provide the same level of grip and responsiveness as high-performance tires. Drivers may experience reduced traction and control. Furthermore, for vehicles designed for off-road or rough terrain driving modes, low-resistance tires may not offer the necessary durability and traction. Off-road and all-terrain driving modes require tires with rugged tread patterns and sidewall strength for durability and traction in challenging terrain. Low resistance tires may be more prone to punctures and damage when driven off-road compared to all-terrain or off-road-specific tires. Moreover, low resistance tires can reduce ride comfort by transmitting more road imperfections and vibrations to the vehicle's cabin, not accounting for if the driver has chosen a comfort or luxury mode. As another example, low resistance tires are often designed with a focus on reducing weight to improve energy efficiency. This can limit their load-carrying capacity, which might be a concern for vehicles that carry heavy loads, such as towing or transporting cargo.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate an artificially intelligent vehicle rolling resistance system. That is, the present inventors realized that various disadvantages associated with existing techniques for minimizing rolling resistance in vehicles can be ameliorated by artificially intelligent provision of vehicle rolling resistance systems.

More specifically, a vehicle can be outfitted with various external sensors, such as road-facing cameras or road-facing microphones. In various aspects, the vehicle can utilize such external sensors to capture vicinity data of a vicinity of the vehicle (e.g., to capture pictures of roadways, sidewalks, or other vehicles that are in the vicinity of the vehicle, to capture noises that occur in the vicinity of the vehicle). Furthermore, the vehicle can be outfitted with a deep learning neural network that can be trained or otherwise configured to detect environment and road conditions based on data captured by the external sensors. Thus, in various instances, the vehicle can execute the deep learning neural network on the vicinity data.

Furthermore, a vehicle can be equipped with internal sensors (e.g., accelerometers, yaw rate sensors, steering angle sensor, accelerator pedal position, brake pedal sensors) to monitor internal vehicle aspects and operations (e.g., tire pressure, tread depth, wheel speed, acceleration, fuel levels, battery levels, engine parameters, braking). In various aspects, the vehicle can be further outfitted with a multi-objective optimization model that can be trained to optimize multiple objectives of vehicle operation (e.g., performance, safety, comfort, energy efficiency) based on driver preferences. Thus, in various instances, the vehicle can execute the multi-objective optimization model on internal vehicle conditions data and output data from executing the deep learning neural network on the vicinity data to achieve driving performance, safety, and minimized rolling resistance for energy efficiency.

Various embodiments described herein can be employed to use hardware or software to solve problems that are highly technical in nature (e.g., to facilitate artificially intelligent provision of vehicle rolling resistance), that are not abstract and that cannot be performed as a set of mental acts by a human. Further, some of the processes performed can be performed by a specialized computer (e.g., a multi-objective optimization model, a deep learning neural network having internal parameters such as convolutional kernels) for carrying out defined tasks related to artificially intelligent vehicle operation.

It should be appreciated that the herein figures and description provide non-limiting examples of various embodiments and are not necessarily drawn to scale.

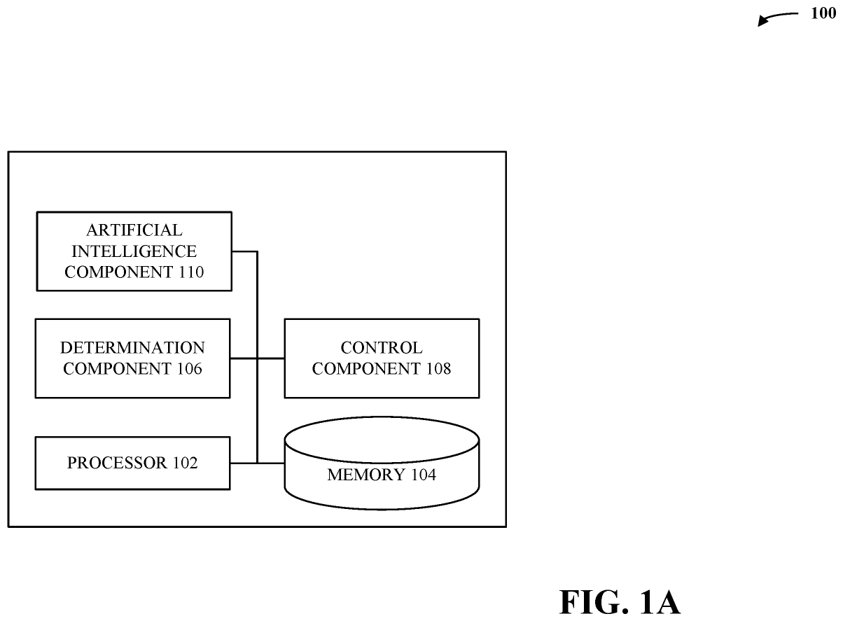

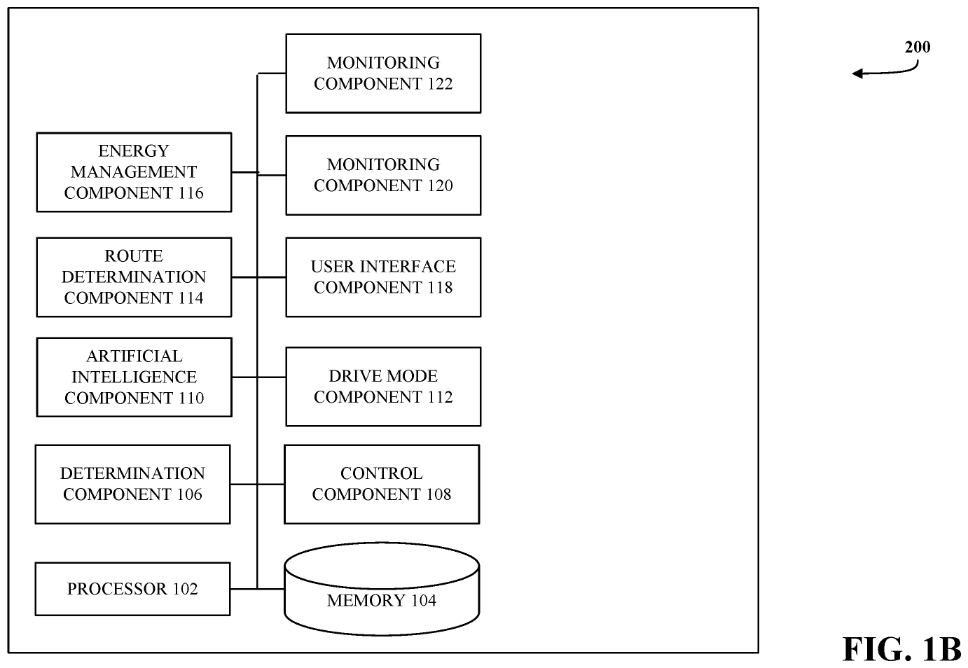

FIG. 1A illustrates a block diagram of an example, non-limiting system 100 that can facilitate an artificially intelligent vehicle rolling resistance system in accordance with one or more embodiments described herein.

In various embodiments, there can be a vehicle. In various aspects, the vehicle can be any suitable vehicle or automobile (e.g., can be a car, a truck, a van, a motorcycle). In various instances, the vehicle can have or otherwise exhibit any suitable type of propulsion system (e.g., can be an electric vehicle, can be a gasoline-powered or diesel-powered vehicle, can be a hybrid vehicle). In some cases, the vehicle can be driving on any suitable road, street, lane, or highway at any suitable speed. In other cases, the vehicle can, while driving, be stopped at an intersection, at a traffic light, at a stop sign, at a cross-walk, or at a traffic jam. In yet other cases, the vehicle can be parked rather than driving (e.g., can be parked in a parking lot, by a curb, or in a driveway). In any case, the vehicle can comprise, have, or otherwise be outfitted or equipped with the system 100. In other words, the system 100 can be onboard the vehicle. In some cases, because the vehicle can comprise the system 100, the vehicle can be considered as a smart vehicle.

In various embodiments, the system 100 can comprise a processor 102 (e.g., computer processing unit, microprocessor) and a non-transitory computer-readable memory 104 that is operably or operatively or communicatively connected or coupled to the processor 102. The non-transitory computer-readable memory 104 can store computer-executable instructions which, upon execution by the processor 102, can cause the processor 102 or other components of the system 100 (e.g., determination component 106, control component 108, artificial intelligence component 110) to perform one or more acts. In various embodiments, the non-transitory computer-readable memory 104 can store computer-executable components (e.g., determination component 106, control component 108, and artificial intelligence component 110).

Turning to FIG. 1B, in various embodiments, the system 100 can comprise a drive mode component 112. In an aspect, the drive mode component receives a sport mode level (standard, sport mode level 1, sport mode level 2, super sport, etc). The sport mode level is used by the drive mode component to configure various aspects of the vehicle. For example, depending on the sport mode, the rolling resistance, tire pressure, transmission, etc. are modified.

In various embodiments, the system 100 can comprise a route determination component 114. The route determination component receives a target location (e.g., geographical location of where the user wants to go). Using the target location and the sport mode, the route determination component determines the one or more route that would provide the best driving experience for the chosen sport mode (e.g., selecting roads with turns versus roads with hills or gravel).

In various embodiments, the system 100 comprise an energy management component 116. The energy management component determines a predicts amount of energy required to use the provided sport mode on the determined route. Using various artificial intelligence and machine learning models, the energy management component can predict a range of energy required if the vehicle is driven is the sport mode throughout the journey (e.g., starting point to a target location).

In various aspects, the system 100 can comprise a user interface component 118. In various instances, as described herein, the user interface component can display the first route determined by the route determination component. For example, the route determination component generates the first route using sport mode and target destination, the route is displayed on an interactive display (e.g., infotainment system or any other display) along with predicted amount of energy required.

In various aspects, the system 100 can comprise a monitoring component 120. The monitoring component monitors vehicle use by monitoring, for example, a wheel angle measurement, a shock usage measurement, and a tire pressure measurement. During the journey, the system can adaptively adjust the rolling resistance based on how the car was driver compared to initial estimates.

In various aspects, the system 100 can comprise a rolling resistance control component 122. The rolling resistance control component adjusts a rolling resistance value based a wheel angle measurement, a shock usage measurement, a tire pressure measurement and an energy consumption measurement. In some aspects, the rolling resistance control component comprises the rolling resistance system that can control the amount a car can roll during turns. In as aspect, the processor 102 can, all or in combination, execute the computer-executable components discussed above.

In accordance to various aspects of system 100, the user provides destination to system 100. The system 100 generates a level of sport mode achievable during the journey and amount of energy required to a given sport mode (the lower the sport mode, the higher the user will feel the roll during turns). For example, at starting point A the user provides destination B. The system determines one or more routes (e.g., starting point A to destination B) and provides what level of sport more can be used on each route. The user is provided an option to increase/decrease the level of sport mode and/or increase/decrease levels of energy to use. Based on these adjustments, the system 100 can provide optimum driving experience to the user. During the journey, the system 100 can adaptively adjust the rolling resistance based on how the car was driver compared to initial estimates. This can be achieved based on monitoring the wheel angles, use of shocks, and tire pressure (i.e., the harder the car is driven, the data for shocks and tire pressure will be altered which the system can use to alter the sport mode if necessary to achieve energy consumption settings).

In various embodiments, the system 100 can comprise a determination component 106. In various instances, as described herein, the determination component 106 can determine whether one or more of a plurality of parameters of a vehicle will result in an acceptable rolling resistance condition for the vehicle.

An acceptable condition of rolling resistance can be dynamically determined based upon the driver's chosen vehicle driving mode, the road conditions, and the vehicle's operating conditions. The determination component can engage artificial intelligence to execute multi-objective optimization to enable a balance between energy efficiency and driving performance in determination of the acceptable rolling resistance condition. Thus, energy efficiency can be achieved while maintaining suitable traction properties of the vehicle. For example, if the vehicle is driving on a straight and smooth road (e.g., a straight highway) the acceptable rolling resistance condition can be minimized to a higher degree. Thus, the wheel camber and toe angles can be adjusted to reduce rolling resistance to a higher degree as no safety hazards regarding traction are present (e.g., slipping, less traction on a winding road, icy road). As another example, if a vehicle is driving on winding and rough surface road, the acceptable rolling resistance condition can be minimized to a lower degree as further grip and traction are desirable to prevent hazardous driving situations (e.g., skidding, slipping, rolling over). Therefore, the wheel camber and toe angles can be adjusted to achieve the suitable grip and traction with the road for such situations. As an even other example, if a driver has chosen sports mode for the vehicle, the acceptable rolling resistance condition can be optimized towards providing driving performance. Thus, the wheel camber and toe angles can be adjusted to adaptively reduce rolling resistance to a lower degree to maintain sports mode handling and performance (e.g., provide more grip while cornering, provide more traction for launch acceleration).

In various instances, the one or more parameters can comprise tire life, tire pressure, tread depth, camber, or toe angle of one or more tires of the vehicle. The one or more parameters can further comprise the energy level, remaining driving range, or velocity of the vehicle. In various aspects, the plurality of parameters can further comprise any suitable internal vehicle states and conditions (steering angle, acceleration, braking, vehicle rotational speed, tire material) In various cases, the one or more parameters can also be external to the vehicle (e.g., road conditions, weather). Thus, the determination component 106 can utilize such parameter data to compute the rolling resistance of the vehicle.

In various aspects, the determination component 106 can utilize real-time data or calibration data of one or more of the plurality of parameters to determine the appropriate adjustments of wheel camber and toe angle to provide an acceptable rolling resistance condition. More specifically, the determination component 106 can be calibrated based on empirical data of tire pressure, tread depth, wheel camber, toe angle, or any other suitable parameters to provide appropriate vehicle states and conditions for an acceptable rolling resistance condition when monitoring of rolling resistance is unattainable or impeded (e.g., sensor failure, extreme conditions, low battery or energy). Thus, the control component 108 can execute the suitable states and conditions (toe angle, camber) based on the calibration data. Conversely, when accurate monitoring of rolling resistance is enabled, the real-time data of one or more of the plurality of parameters can be directly utilized by the determination component 106 to compute the rolling resistance of the vehicle and by the control component 108 to execute the determined adjustments (e.g., adjusting camber or toe angle). Thus, the appropriate changes to the chassis settings can be dynamically adjusted to achieve minimized rolling resistance and suitable traction.

In various embodiments, the system 100 can comprise a control component 108. In various cases, as described herein, the control component 108 can control one or more aspects of the vehicle based on a determination that the one or more of the plurality of parameters of the vehicle will fail to result in an acceptable rolling resistance condition.

In various embodiments, the control component 108 can conduct, initiate, facilitate, or otherwise perform any suitable electronic actions, in response to the determination component 106 (e.g., in response to a determination that one or more of the plurality of parameters of the vehicle will fail to result in an acceptable rolling resistance condition). In contrast, the control component 108 can, in various instances, refrain from conducting, initiating, facilitating, or otherwise performing such electronic actions, in response to the determination component 106 (e.g., in response to a determination that one or more of the plurality of parameters of the vehicle do result in an acceptable rolling resistance condition).

In various embodiments, the system 100 can comprise an artificial intelligence component 110. In various cases, as described herein, the determination component 106 can engage the artificial intelligence component 110 to use machine learning on the plurality of vehicle parameters to calculate the current rolling resistance of the vehicle and determine the optimal parameters to minimize rolling resistance. For example, if a vehicle is driving on a highway, the determination component 106 can engage the artificial intelligence component 110 to calculate and determine the amount to raise the tire pressure of one or more of the vehicle tires and the reduction in tread depth to mitigate rolling resistance. Conversely, if a vehicle is driving on rough terrain, the determination component 106 can engage the artificial intelligence component 110 to calculate and determine the amount to reduce the tire pressure of one or more of the vehicle tires and the increase in tread depth to minimize rolling resistance while maximizing the grip and traction of the tires on the road. Accordingly, the control component 108 can then execute or facilitate such adjustments on the vehicle. As another example, if a vehicle is taking a sharp turn, the artificial intelligence component 110 can factor various other parameters (e.g., grade and degree of curvature of the road, vehicle velocity, presence of ice or rain, road surface quality) to determine the optimal adjustments that also mitigate risk of slipping or rolling over.

In various instances, the artificial intelligence component 110 can optimize adjustments of vehicle operation based on the chosen driving mode of the vehicle. For example, if a driver has chosen sports mode, minimum rolling resistance to achieve energy efficiency and energy conservation can be attained by adjusting the tire pressure, tread depth, camber, and toe angle for launch and acceleration of the vehicle. Furthermore, the artificial intelligence component 110 can determine energy reroute actions to perform to support the power output of sports mode by rerouting energy from other vehicle tasks.

In various aspects, the vehicle can also allow for a non-adaptable mode to provide the driver a choice of utilizing the adaptable and dynamic systems to minimize rolling resistance. For example, a driver can choose sports mode and further choose a non-adaptable mode. In such instances, the control component 108 will not execute any determined adjustments (e.g., tire pressure change, dynamic speed, camber change) to enable full driving performance of sports mode.

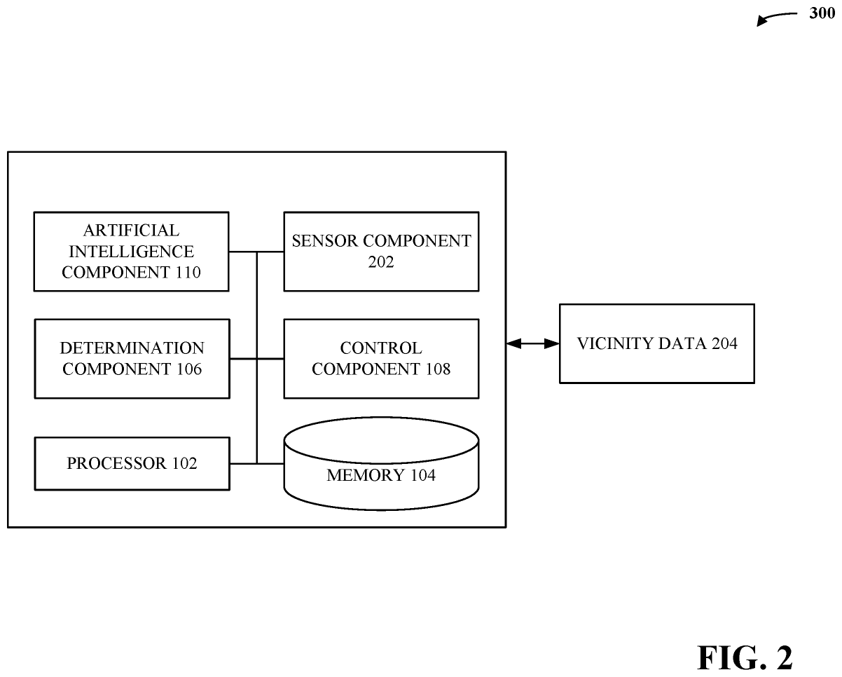

FIG. 2 illustrates a block diagram of an example, non-limiting system 200 that can facilitate an artificially intelligent vehicle rolling resistance system in accordance with one or more embodiments described herein. As shown, the system 200 can, in some cases, comprise the same components as the system 100, and can further comprise a sensor component 202.

In various aspects, as described herein, the sensor component 202 can obtain, via any suitable sensors of the vehicle, vicinity data 204. In various cases, the vicinity data 204 can exhibit any suitable format, size, or dimensionality. For example, the vicinity data 204 can comprise one or more scalars, one or more vectors, one or more matrices, one or more tensors, one or more character strings, or any suitable combination thereof.

In various aspects, the sensor component 202 can be various external sensors, such as road-facing cameras or road-facing microphones. In various aspects, the vehicle can utilize such external sensors to capture vicinity data of a vicinity of the vehicle (e.g., to capture pictures of roadways, sidewalks, pedestrians, or other vehicles that are in the vicinity of the vehicle, to capture noises that occur in the vicinity of the vehicle). For example, the sensor component 202 can capture conditions of the road that the vehicle is driving upon (e.g., surface texture, grade, curvature angle). Thus, the determination component 106 can engage the artificial intelligence 110 to access such sensor data and determine if weather or road conditions are met to form various hazardous conditions. Accordingly, the artificial intelligence component 110 can determine how to adjust vehicle parameters (e.g., alter tire pressure, tread depth, camber, or toe angle of the tires) to handle such hazard predictions.

In various instances, a vehicle can be equipped with internal sensors (e.g., laser sensors, pressure sensors, ultrasonic sensors, infrared sensors, visual sensors) to monitor internal vehicle aspects and operations (e.g., tire pressure, tread depth, wheel speed, acceleration, fuel levels, battery levels, engine parameters). For example, pressure sensors can be utilized to actively measure the tire pressure of one or more tires of the vehicle (e.g., tire pressure monitoring system). As another example, a laser sensor can be utilized to actively measure and monitor a tire's tread depth by emitting a light beam onto a tire's surface and calculate the depth of the tire by analyzing the reflection and refraction of the light. Thus, the determination component 106 can access the monitored data by various internal sensors to dynamically calculate rolling resistance and the parameter adjustments.

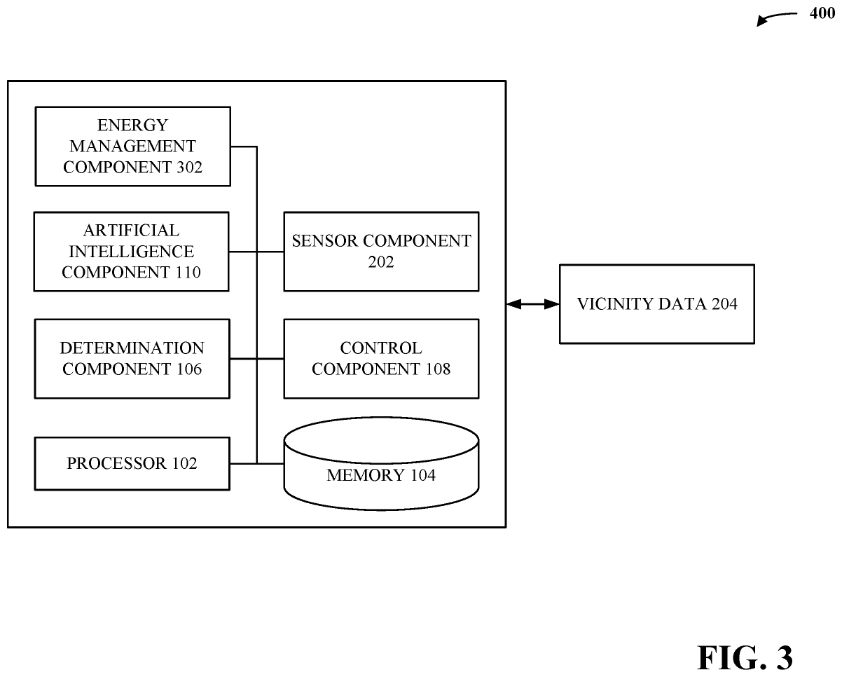

FIG. 3 illustrates a block diagram of an example, non-limiting system 300 including an energy management component that can facilitate an artificially intelligent vehicle rolling resistance system in accordance with one or more embodiments described herein. As shown, the system 300 can, in some cases, comprise the same components as the system 200, and can further comprise an energy management component 302.

In various embodiments, the energy management component 302 can monitor and manage the allocation, distribution, and usage of energy resources in the vehicle. In various embodiments, the control component 108 can engage the energy management component 302 to operate piezoelectric circuits to monitor and dynamically adjust the tire pressure or tread depth of one or more tires of the vehicle. More specifically, dynamic adjustments of tire pressure or tread depth can be achieved by utilizing a piezoelectric effect to convert electrical energy into mechanical motion on piezoelectric material. The control component 108 can engage the energy management component 302 to apply electrical voltage to piezoelectric material in the tire, causing deformation or mechanical stress that can be controlled to expand the tread blocks of a tire. Conversely, the same effect can be utilized to contract the tread blocks of a tire by reversal of voltage. For example, if a vehicle is traversing a snowy road, the control component 108 can engage the energy management component 302 to distribute power to the piezoelectric circuit so a negative voltage can be applied to enable contraction of tread blocks and extending of tread depth for more suitable grip in snow (e.g., deeper tread for less snow buildup). Thus, dynamic tire pressure and tread depth can be achieved by continuous parameter monitoring and the control component 108 actively executing adjustments in response to a determination that the one or more of the plurality of parameters will fail to result in an acceptable rolling resistance (e.g., current rolling resistance is not suitable for snowy weather because the tread depth is shallow and thus, not providing a suitable grip). Furthermore, the control component 108 can implement dynamic tire pressure and tread depth in response to a determination that current vehicle operating conditions may result in a hazardous situation (e.g., contract tread blocks for extended tread depth when driving on a wet road).

Moreover, the control component 108 can engage the energy management component 302 to operate a linear actuator to dynamically change the toe angle or camber of vehicle tires. Thus, dynamic camber and toe angle changes can be achieved by continuous parameter monitoring and the control component 108 actively executing adjustments in response to a determination that the one or more of the plurality of parameters will fail to result in an acceptable rolling resistance or may cause a hazardous situation. For example, if the determination component 106 detects that the vehicle fails to have an acceptable rolling resistance (e.g., current vehicle parameters not suitable for off-roading, load handling, cornering, eco-driving), the control component 108 can engage the energy management component 302 to activate the linear actuator to establish a positive, negative, or zero camber of the vehicle tires based on the detected environment and operating conditions (e.g., executing positive camber for off-roading, zero camber for even tire wear, negative camber to compensate for suspension wear, negative camber for cornering). By dynamically adjusting the camber, rolling resistance can be minimized while still achieving driving performance based on the detected situations. Furthermore, the control component 108 can engage the energy management component 302 to activate the linear actuator to cause the vehicle tires to be toe-in or toe-out. For example, if the vehicle is cornering, the control component 108 can make the vehicle tires toe-out to enhance cornering response and handling.

In various instances, the control component 108 can engage the energy management component 302 to reroute energy or halt energy distribution from any suitable electric loads of the vehicle. In various aspects, the energy management component 302 can continually or periodically compare the remaining battery life (e.g., remaining battery charge) of the vehicle to any suitable threshold (e.g., the suitable threshold can be based on the chosen driving mode of the vehicle, an inputted navigation route or destination, determined minimum distance or mileage remaining). If the remaining battery life of the vehicle falls below the threshold, then the determination component 106 can determine any suitable adjustments to vehicle operation to extend battery life. For example, if the remaining battery life of the vehicle falls below the threshold, the control component 108 can halt execution of dynamic tire pressure and tread depth to preserve energy. As another example, if a seat heater or seat cooler of the vehicle is running during, then the battery component can power-down the seat heater or seat cooler, in response to a determination that the remaining battery life of the vehicle is below the threshold (e.g., the battery component can cease expending battery power on the seat heater or seat cooler, so that more battery power is available to sustain driving operation of the vehicle). Moreover, if the chosen driving mode of the vehicle is comfort mode for example, the energy management component 302 can engage the artificial intelligence component 110 to determine alternative energy reroute actions in place of powering down seat heaters or coolers.

In various aspects, the energy management component 302 can continually or periodically compare the remaining driving range (e.g., remaining distance the vehicle can drive before running out of fuel or battery) of the vehicle to any suitable threshold. If the remaining driving range of the vehicle falls below the threshold, then the determination component 106 can determine any suitable adjustments to vehicle operation to extend driving range. For example, the determination component 106 can engage the control component 108 to initiate dynamic tire pressure to minimize rolling resistance and thus enhance energy efficiency. As another example, the determination component 106 can engage the control component 108 to switch the driving mode of the vehicle (e.g., switching from sports mode to eco-mode, switching to electric mode in a hybrid vehicle).

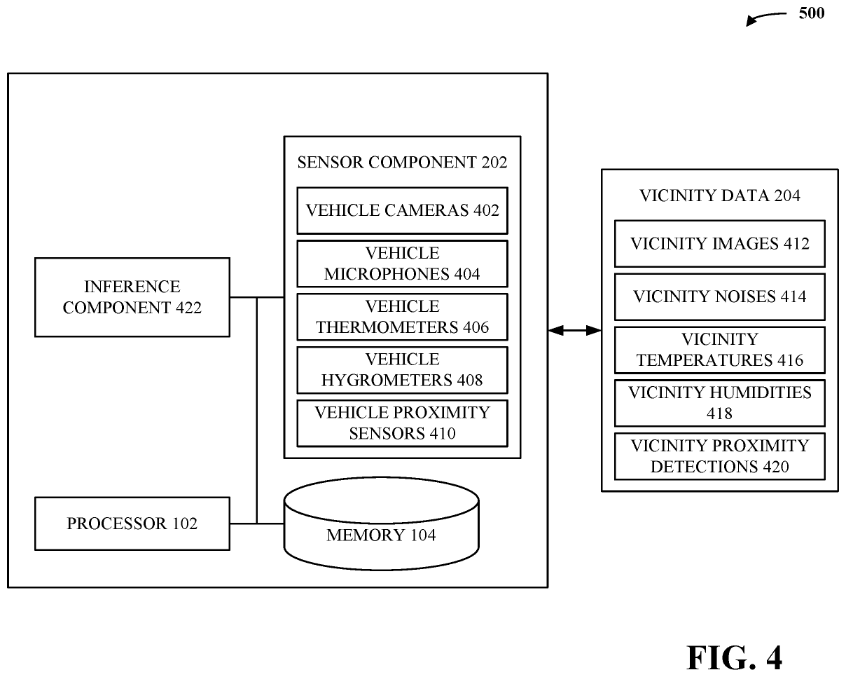

FIG. 4 illustrates a block diagram of an example, non-limiting system 400 that can facilitate an artificially intelligent vehicle rolling resistance system in accordance with one or more embodiments described herein.

In various embodiments, the sensor component 202 can electronically control, electronically execute, electronically activate, or otherwise electronically access any suitable sensors of the vehicle. In various aspects, such sensors can be external or road-facing. In other words, such sensors can be oriented or otherwise configured to monitor the surroundings of the vehicle as the vehicle drives around or is parked.

As a non-limiting example, such sensors can include a set of vehicle cameras 402. In various aspects, the set of vehicle cameras 402 can include any suitable number of any suitable types of cameras (e.g., of image-capture devices). In various instances, the set of vehicle cameras 402 can be integrated into or onto the vehicle. In various cases, one or more of the set of vehicle cameras 402 can be forward-facing. For example, such one or more cameras can be integrated into or onto any suitable forward-facing surfaces, whether interior or exterior, of the vehicle (e.g., can be built on a dash of the vehicle so as to look through a front windshield of the vehicle, can be built around the front windshield of the vehicle, can be built into a front bumper of the vehicle, can be built around headlights of the vehicle, can be built into a hood of the vehicle). Because such one or more cameras can be forward-facing, such one or more cameras can be configured to capture or otherwise record images or video frames of portions of the vicinity that lie in front of the vehicle. In various aspects, one or more of the set of vehicle cameras 402 can be rearward-facing. For example, such one or more cameras can be integrated into or onto any suitable rearward-facing surfaces, whether interior or exterior, of the vehicle (e.g., can be built into or on a rearview mirror of the vehicle, can be built into or onto sideview mirrors of the vehicle, can be built around a rear windshield of the vehicle, can be built into a rear bumper of the vehicle, can be built around taillights of the vehicle, can be built into a trunk-cover of the vehicle). Because such one or more cameras can be rearward-facing, such one or more cameras can be configured to capture or otherwise record images or video frames of portions of the vicinity that lie behind the vehicle. In various instances, one or more of the set of vehicle cameras 402 can be laterally-facing. For example, such one or more cameras can be integrated into or onto any suitable lateral surfaces, whether interior or exterior, of the vehicle (e.g., can be built into or around doors or door handles of the vehicle, can be built into or around fenders of the vehicle). Because such one or more cameras can be laterally-facing, such one or more cameras can be configured to capture or otherwise record images or video frames of portions of the vicinity that lie beside the vehicle.

As another non-limiting example, such sensors can include a set of vehicle microphones 404. In various aspects, the set of vehicle microphones 404 can include any suitable number of any suitable types of microphones (e.g., of sound-capture devices). In various instances, the set of vehicle microphones 404 can be integrated into or onto the vehicle. In various cases, one or more of the set of vehicle microphones 404 can be forward-facing. For example, such one or more microphones can be integrated into or onto any suitable forward-facing surfaces, whether interior or exterior, of the vehicle, so as to capture or otherwise record sounds or noises that occur in portions of the vicinity that lie in front of the vehicle. In various aspects, one or more of the set of vehicle microphones 404 can be rearward-facing. For example, such one or more microphones can be integrated into or onto any suitable rearward-facing surfaces, whether interior or exterior, of the vehicle, so as to capture or otherwise record sounds or noises that occur in portions of the vicinity that lie behind the vehicle. In various instances, one or more of the set of vehicle microphones 404 can be laterally-facing. For example, such one or more microphones can be integrated into or onto any suitable lateral surfaces, whether interior or exterior, of the vehicle, so as to capture or otherwise record sounds or noises that occur in portions of the vicinity that lie beside the vehicle.

As yet another non-limiting example, such sensors can include a set of vehicle thermometers 406. In various aspects, the set of vehicle thermometers 406 can include any suitable number of any suitable types of thermometers (e.g., of temperature sensors). In various instances, the set of vehicle thermometers 406 can be integrated into or onto the vehicle. In various cases, one or more of the set of vehicle thermometers 406 can be forward-facing. For example, such one or more thermometers can be integrated into or onto any suitable forward-facing surfaces, whether interior or exterior, of the vehicle, so as to capture or otherwise record air temperatures or road surface temperatures associated with portions of the vicinity that lie in front of the vehicle. In various aspects, one or more of the set of vehicle thermometers 406 can be rearward-facing. For example, such one or more thermometers can be integrated into or onto any suitable rearward-facing surfaces, whether interior or exterior, of the vehicle, so as to capture or otherwise record air temperatures or road surface temperatures associated with portions of the vicinity that lie behind the vehicle. In various instances, one or more of the set of vehicle thermometers 406 can be laterally-facing. For example, such one or more thermometers can be integrated into or onto any suitable lateral surfaces, whether interior or exterior, of the vehicle, so as to capture or otherwise record air temperatures or road surface temperatures associated with portions of the vicinity that lie beside the vehicle.

As even another non-limiting example, such sensors can include a set of vehicle hygrometers 408. In various aspects, the set of vehicle hygrometers 408 can include any suitable number of any suitable types of hygrometers (e.g., of moisture or humidity sensors). In various instances, the set of vehicle hygrometers 408 can be integrated into or onto the vehicle. In various cases, one or more of the set of vehicle hygrometers 408 can be forward-facing. For example, such one or more hygrometers can be integrated into or onto any suitable forward-facing surfaces, whether interior or exterior, of the vehicle, so as to capture or otherwise record air humidities or road surface moisture levels associated with portions of the vicinity that lie in front of the vehicle. In various aspects, one or more of the set of vehicle hygrometers 408 can be rearward-facing. For example, such one or more hygrometers can be integrated into or onto any suitable rearward-facing surfaces, whether interior or exterior, of the vehicle, so as to capture or otherwise record air humidities or road surface moisture levels associated with portions of the vicinity that lie behind the vehicle. In various instances, one or more of the set of vehicle hygrometers 408 can be laterally-facing. For example, such one or more hygrometers can be integrated into or onto any suitable lateral surfaces, whether interior or exterior, of the vehicle, so as to capture or otherwise record air humidities or road surface moisture levels associated with portions of the vicinity that lie beside the vehicle.

As still another non-limiting example, such sensors can include a set of vehicle proximity sensors 410. In various aspects, the set of vehicle proximity sensors 410 can include any suitable number of any suitable types of proximity sensors (e.g., of radar, sonar, or lidar sensors). In various instances, the set of vehicle proximity sensors 410 can be integrated into or onto the vehicle. In various cases, one or more of the set of vehicle proximity sensors 410 can be forward-facing. For example, such one or more proximity sensors can be integrated into or onto any suitable forward-facing surfaces, whether interior or exterior, of the vehicle, so as to capture or otherwise record proximities of tangible objects located in portions of the vicinity that lie in front of the vehicle. In various aspects, one or more of the set of vehicle proximity sensors 410 can be rearward-facing. For example, such one or more proximity sensors can be integrated into or onto any suitable rearward-facing surfaces, whether interior or exterior, of the vehicle, so as to capture or otherwise record proximities of tangible objects located in portions of the vicinity that lie behind the vehicle. In various instances, one or more of the set of vehicle proximity sensors 410 can be laterally-facing. For example, such one or more proximity sensors can be integrated into or onto any suitable lateral surfaces, whether interior or exterior, of the vehicle, so as to capture or otherwise record proximities of tangible objects located in portions of the vicinity that lie beside the vehicle.

In any case, the sensor component 202 can utilize such sensors to capture, record, or otherwise measure the vicinity data 204.

For example, the set of vehicle cameras 402 can capture a set of vicinity images 412 while the vehicle is driving or parked. In various aspects, the set of vicinity images 412 can include any suitable number of images or video frames (e.g., any suitable number of two-dimensional pixel arrays) that can depict portions of the vicinity (e.g., portions of the vicinity that lie in front of, behind, or beside the vehicle).

As another example, the set of vehicle microphones 404 can capture a set of vicinity noises 414 while the vehicle is driving or parked. In various instances, the set of vicinity noises 414 can include any suitable number of audio clips that can represent noises occurring in portions of the vicinity (e.g., in portions of the vicinity that lie in front of, behind, or beside the vehicle).

As yet another example, the set of vehicle thermometers 406 can capture a set of vicinity temperatures 416 while the vehicle is driving or parked. In various aspects, the set of vicinity temperatures 416 can include any suitable number of temperature measurements that can represent air temperatures or road surface temperatures associated with portions of the vicinity (e.g., with portions of the vicinity that lie in front of, behind, or beside the vehicle).

As still another example, the set of vehicle hygrometers 408 can capture a set of vicinity humidities 418 while the vehicle is driving or parked. In various aspects, the set of vicinity humidities 418 can include any suitable number of humidity measurements or moisture measurements that can represent air humidity levels or road surface moisture levels associated with portions of the vicinity (e.g., with portions of the vicinity that lie in front of, behind, or beside the vehicle).

As even another example, the set of vehicle proximity sensors 410 can capture a set of vicinity proximity detections 420 while the vehicle is driving or parked. In various aspects, the set of vicinity proximity detections 420 can include any suitable number of proximity detections (e.g., of radar, sonar, or lidar detections) that can represent distances between the vehicle and nearby objects located in portions of the vicinity (e.g., in portions of the vicinity that lie in front of, behind, or beside the vehicle).

In any case, the set of vicinity images 412, the set of vicinity noises 414, the set of vicinity temperatures 416, the set of vicinity humidities 418, and the set of vicinity proximity detections 420 can collectively be considered as the vicinity data 204.

In various embodiments, the system 300 can comprise an inference component 422. In various instances, as described herein, the inference component 422 can detect environment and road conditions within the vicinity, based on the vicinity data 204.

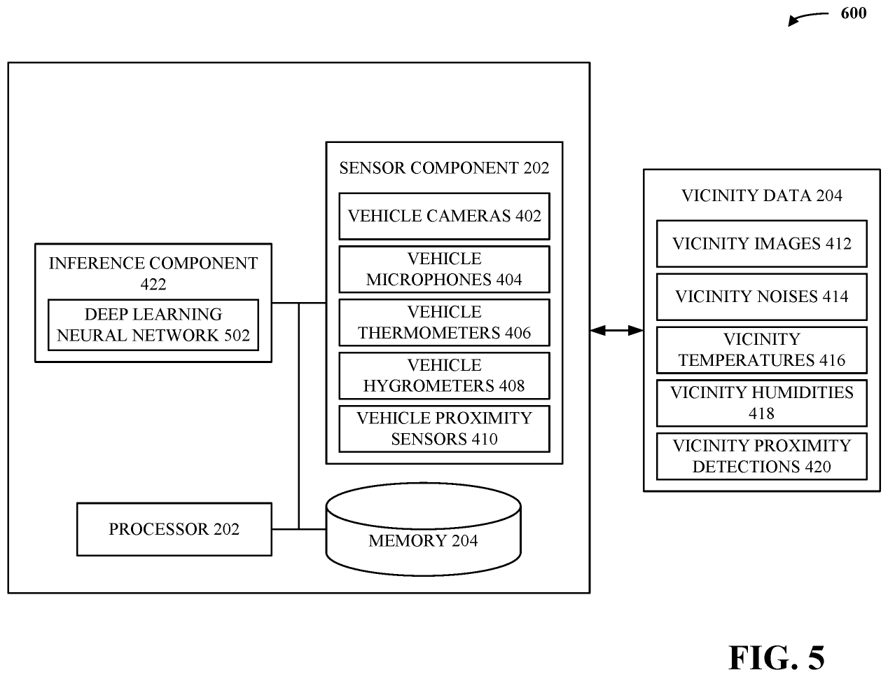

FIG. 5 illustrates a block diagram of an example, non-limiting system 500 including a deep learning neural network that can facilitate an artificially intelligent vehicle rolling resistance system in accordance with one or more embodiments described herein. As shown, the system 500 can, in some cases, comprise the same components as the system 400, and can further comprise a deep learning neural network 502.

In various embodiments, the inference component 422 can electronically store, electronically maintain, electronically control, or otherwise electronically access the deep learning neural network 502. In various aspects, the deep learning neural network 502 can have or otherwise exhibit any suitable internal architecture. For instance, the deep learning neural network 502 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

No matter the internal architecture of the deep learning neural network 502, the deep learning neural network 502 can be configured to detect surrounding road and environment conditions based on input vicinity data.

As shown, the inference component 422 can, in various aspects, execute the deep learning neural network 502 on the vicinity data 204, and such execution can cause the deep learning neural network 502 to produce detections of obstacles or hazardous roadway conditions. More specifically, the inference component 422 can feed the vicinity data 204 (e.g., the set of vicinity images 412, the set of vicinity noises 414, the set of vicinity temperatures 416, the set of vicinity humidities 418, or the set of vicinity proximity detections 420) to an input layer of the deep learning neural network 502. In various instances, the vicinity data 204 (e.g., the set of vicinity images 412, the set of vicinity noises 414, the set of vicinity temperatures 416, the set of vicinity humidities 418, or the set of vicinity proximity detections 420) can complete a forward pass through one or more hidden layers of the deep learning neural network 502. In various cases, an output layer of the deep learning neural network 502 can detect obstacles or hazardous conditions, based on activation maps or intermediate features produced by the one or more hidden layers.

In various embodiments, the inference component 422 can execute the deep learning neural network 502 on the vicinity data 204 to detect potential obstructions or hazardous road conditions (e.g., a cone misplaced in the middle of the highway lane, a deer suddenly crossing a road, wet or slippery roads, swerving of a surrounding vehicle, driving on a steep downhill grade). For instance, the sensor component 202 can capture the vicinity data 204 when the vehicle is in motion, and the deep learning neural network 502 can be trained or otherwise configured to determine, based on the vicinity data 204, whether such dangerous conditions are occurring. In other words, if such conditions are occurring, some manifestation of such conditions can be conveyed in the vicinity data 204 (e.g., rainfall can be depicted in the set of vicinity images 412, distinctive sounds of the rainfall can be captured in the set of vicinity noises 414, the rainfall can cause a distinctive anomaly in the set of vicinity proximity detections 420, rainfall can be detected in the set of vicinity humidities 418), and the deep learning neural network 502 can recognize such manifestation of the conditions (e.g., the presence and severity of the rainfall). Accordingly, the determination component 106 can, in response to such detections by the inference component 422, engage the control component 108 to execute the optimal vehicle operations (e.g., deepen tire tread, increase tire pressure).

For example, the inference component 422 can detect the presence of strong winds (e.g., windy weather, wind from passing large trucks) captured by the sensor component 202 in the vicinity data 204. If such conditions are occurring, some manifestation of such conditions can be conveyed in the vicinity data 204 (e.g., moving objects or approaching trucks can be depicted in the set of vicinity images 412, distinctive sounds of the wind can be captured in the set of vicinity noises 414), and the deep learning neural network 502 can recognize such manifestation of the conditions (e.g., the presence and severity of the wind). In response to such determination of the presence of strong winds, the control component 108 can implement dynamic speed control of the vehicle to provide the driver with more control if the wind is causing instability or the vehicle to sway.

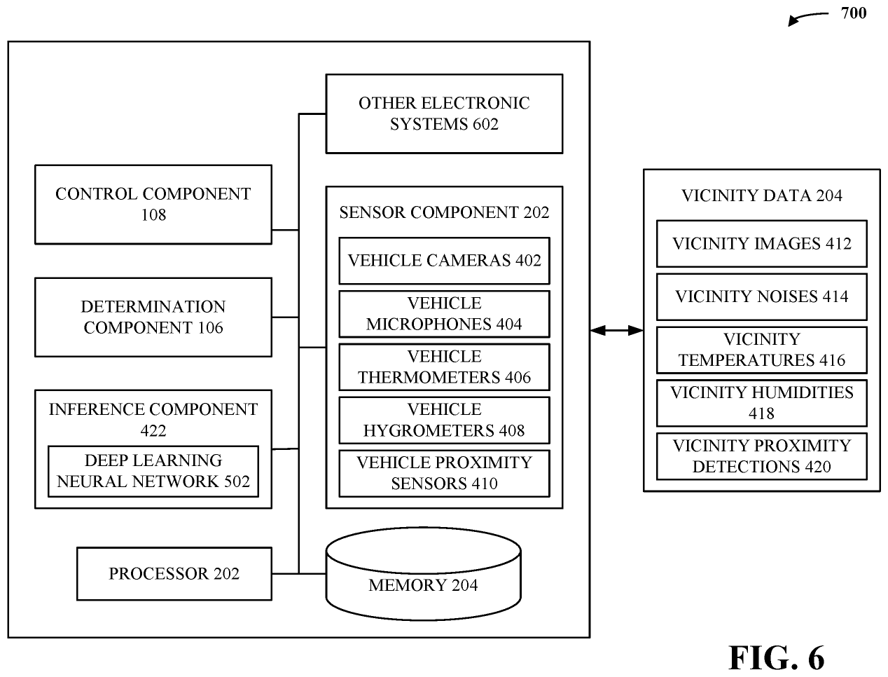

FIG. 6 illustrates a block diagram of an example, non-limiting system 600 including other electronic systems that can facilitate an artificially intelligent vehicle rolling resistance system in accordance with one or more embodiments described herein. As shown, the system 600 can, in some cases, comprise the same components as the system 500, and can further comprise one or more other electronic systems 602.

In various embodiments, the other electronic systems 602 can include one or more additional systems of the vehicle that can be controlled based at least in part on commands issued by the vehicle virtualization component 106. For example, the other electronic systems 602 can include a media system (e.g., audio and/or video), a back-up camera system, an HVAC system, a lighting system, a cruise control system, a power locking system, a navigation system, a self-driving system, a vehicle sensor system, and the like.

In various embodiments, the control component 108 can provide operation of the linear actuator based on external application request from the other electronic systems 602. More specifically, the control component 108 can operate the linear actuator to dynamically adjust the camber or toe angle of one or more tires of the vehicle upon request from one or more of the other electronic systems 602. For example, an active safety system of the vehicle can request operation of the linear actuator to adjust wheel camber or toe angle to avoid a hazardous roadway condition. Furthermore, the other electronic systems can request information from the artificial intelligent rolling resistance system to make judgements or adjustments of operation. For example, the active safety system can make use of actuator positions or actuator forces to enhance active safety mitigation (e.g., use actuator position and forces to mitigate vehicle roll over on a sharp turn or dynamically adjust vehicle speed). As another example, an active safety system can use actuator position or actuator force information to display alerts on a vehicle display when hazardous conditions are detected.

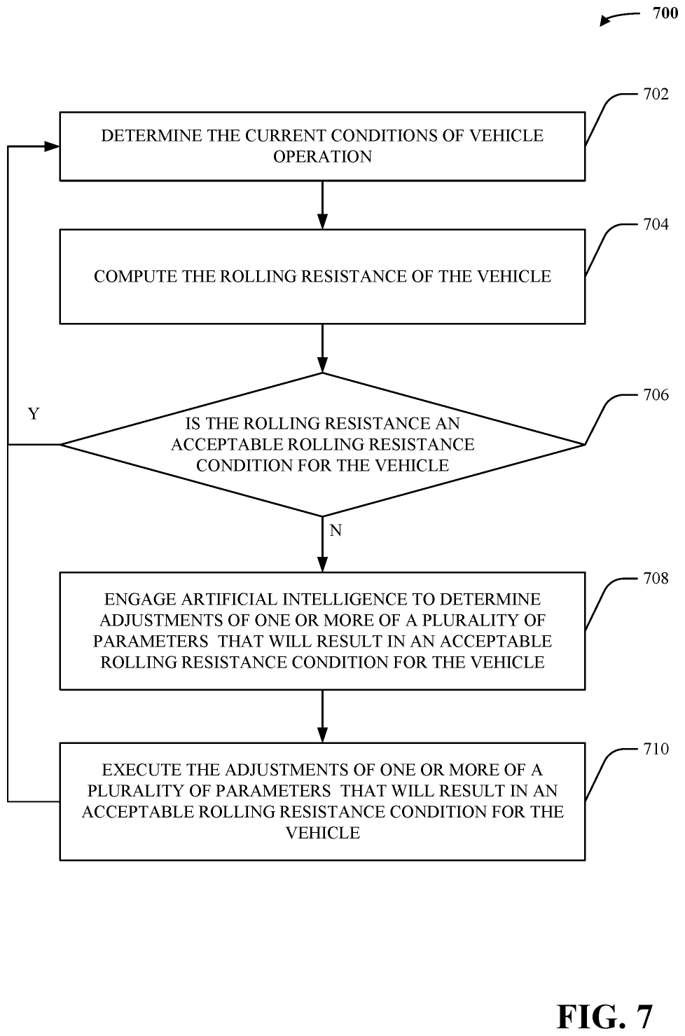

FIG. 7 illustrates a flow diagram of an example, non-limiting computer-implemented method 700 that can facilitate an artificially intelligent vehicle rolling resistance system in accordance with one or more embodiments described herein. In various cases, the system 100 can facilitate the computer-implemented method 700.

In various embodiments, act 702 can include determining, by the determination component (e.g., 106), the current conditions of vehicle operation.

In various aspects, act 704 can include computing, by the artificial intelligence component (e.g., 110), the rolling resistance of the vehicle.

In various cases, act 706 can include determining, by the determination component (e.g., 106), whether the calculated rolling resistance is an acceptable rolling resistance condition for the vehicle. If not (e.g., if the calculated rolling resistance is not an acceptable rolling resistance condition for the vehicle), the computer-implemented method 700 can proceed to act 708. If so (e.g., if the calculated rolling resistance is an acceptable rolling resistance condition for the vehicle), the computer-implemented method 700 can proceed to act 702.

In various aspects, act 708 can include engaging, by the determination component (e.g., 106), the artificial intelligence component (e.g., 110) to determine adjustments of one or more of a plurality of parameters that will result in an acceptable rolling resistance condition for the vehicle.

In various embodiments, act 710 can include executing, by the control component (e.g., 108), the one or more of the plurality of parameters that will result in an acceptable rolling resistance condition for the vehicle.

For example, a vehicle can be in sports mode while driving on a gravel road with shallow tread depth. In such a situation, the determination component (e.g., 106) can determine that the rolling resistance is not an acceptable rolling resistance condition for the vehicle. Accordingly, the control component (e.g., 108) can, in response to the determination, engage the artificial intelligence component (e.g., 110) to determine the optimal adjustments of vehicle operation that will result in an acceptable rolling resistance in such situation. For example, the artificial intelligence component (e.g., 110) may determine that tread depth must be deeper by a determined amount and tire pressure must be raised to the manufacturer's recommended tire pressure to minimize rolling resistance on the gravel road. Thus, the control component (e.g., 108) can execute the determined adjustments while the vehicle is driving.

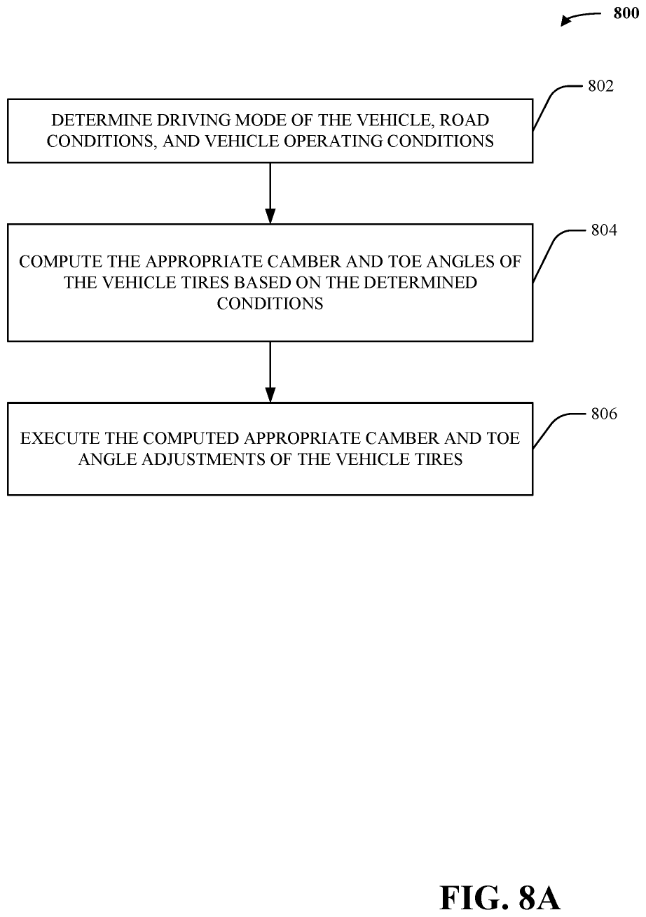

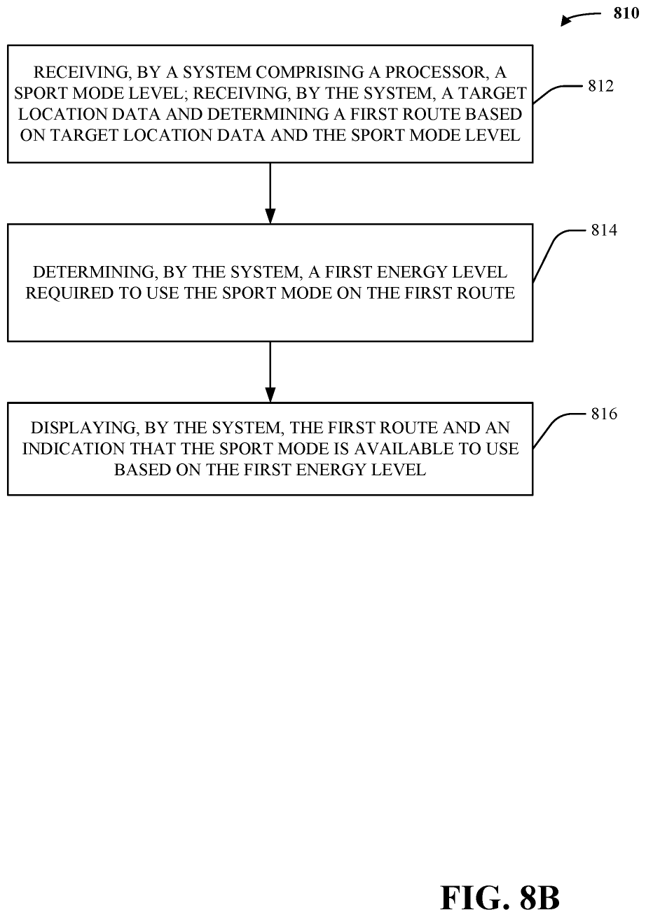

FIG. 8A illustrates a flow diagram of an example, non-limiting computer-implemented method 800 that can facilitate an artificially intelligent vehicle rolling resistance system in accordance with one or more embodiments described herein. In various cases, the system 100 can facilitate the computer-implemented method 800.

In various embodiments, act 802 can include determining, by the determination component (e.g., 106), the current driving mode of the vehicle selected by the driver, the road conditions, and the vehicle operating conditions.

In various aspects, act 804 can include computing, by the artificial intelligence component (e.g., 110), the appropriate camber and toe angle of the vehicle tires that would provide an acceptable rolling resistance condition based on the determined conditions.

In various aspects, act 806 can include executing, by the control component (e.g., 108), the computed appropriate camber and toe angle adjustments of the vehicle.

For example, a driver can choose for the vehicle to be in sports mode while driving on a wet road. In various instances, the vehicle can currently be operating with chassis settings consisting of a toe-out angle and a positive camber. Thus, the artificial intelligence component 110 can determine that chassis settings consisting of a toe-in angle and a slightly positive camber is desirable for a vehicle traversing a wet road to maintain a suitable amount of traction while reducing rolling resistance. Accordingly, the control component 108 can execute such adjustments by operating a linear actuator to adjust the chassis settings to consist a toe-in angle and a slightly positive camber of the wheels.

FIG. 8B illustrates a flow diagram of an example, non-limiting computer-implemented method 810 that can facilitate an artificially intelligent vehicle rolling resistance system in accordance with one or more embodiments described herein. In various cases, the system 100 can facilitate the computer-implemented method 810.

At 812, the system, utilizing a processor, receives a sport mode level; receiving, by the system, a target location data and determining a first route based on target location data and the sport mode level.

At 812, the system determines a first energy level required to use the sport mode on the first route.

At 814, the system displays the first route and an indication that the sport mode is available to use based on the first energy level.

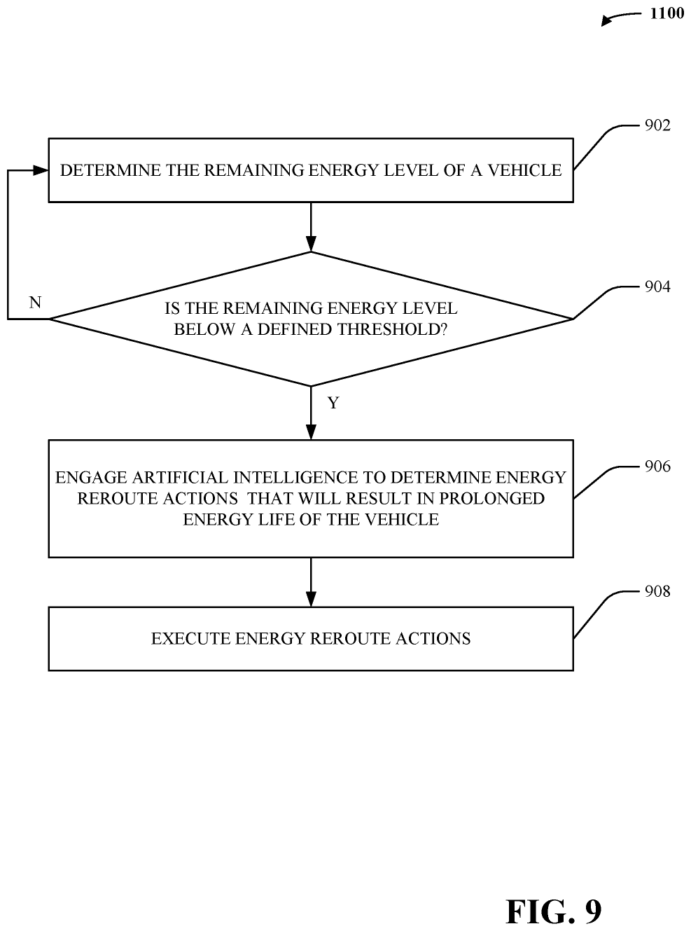

FIG. 9 illustrates a flow diagram of an example, non-limiting computer-implemented method 900 that can facilitate an artificially intelligent vehicle rolling resistance system in accordance with one or more embodiments described herein. In various cases, the system 100 can facilitate the computer-implemented method 900.

In various embodiments, act 902 can include determining, by the determination component (e.g., 106) the remaining energy level of a vehicle.

In various cases, act 904 can include determining, by the determination component (e.g., 106), whether the remaining energy level is below a defined threshold. If not (e.g., if the remaining energy level is not below a defined threshold), the computer-implemented method 900 can proceed to act 902. If so (e.g., if the remaining energy level is below a defined threshold), the computer-implemented method 900 can proceed to act 906.

In various aspects, act 906 can include engaging, by the determination component (e.g., 106), the artificial intelligence component (e.g., 110) to determine energy reroute actions that will result in prolonged energy life of the vehicle.

In various cases, act 908 can include executing, by the control component (e.g. 108) the determined energy reroute actions.

For example, a vehicle can have low battery while driving through snowy and cold weather. In such situation, the determination component (e.g., 106) can determine that the energy level of the vehicle is below a defined threshold. Therefore, in response to the determination, the control component (e.g., 108) can engage the artificial intelligence component (e.g., 110) to determine energy reroute actions that will result in prolonged energy life of the vehicle. For example, the artificial intelligence component (e.g., 110) may determine that dynamic speed adjustment and dynamic tire pressure and tread depth should be powered off. Furthermore, the sensor component 202 may record below-freezing temperatures from the vehicle thermometers 406. Thus, the determined energy reroute actions may ensure that in-cabin climate control (e.g., seat heaters, temperature control) is not powered-off or rerouted energy from. Accordingly, the control component (e.g., 108) can engage the energy management component (e.g., 302) to execute the determined energy reroute actions.

Although the herein disclosure mainly describes various embodiments as implementing deep learning neural networks (e.g., 502), this is a mere non-limiting example. In various aspects, the herein-described teachings can be implemented via any suitable machine learning models exhibiting any suitable artificial intelligence architectures (e.g., support vector machines, naïve Bayes, linear regression, logistic regression, decision trees, random forest).

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

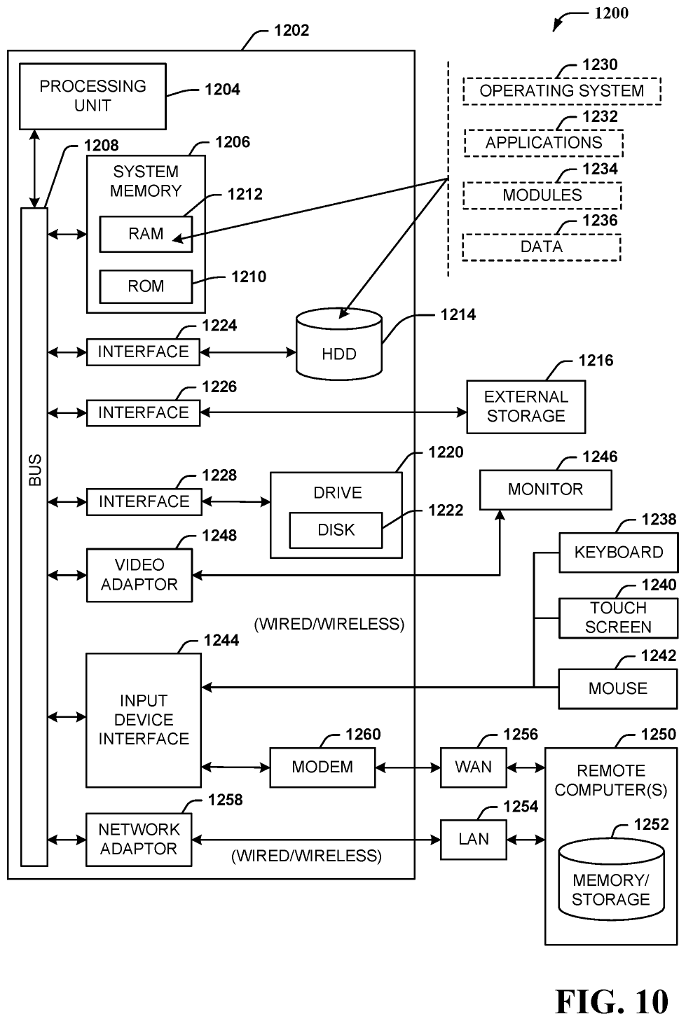

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

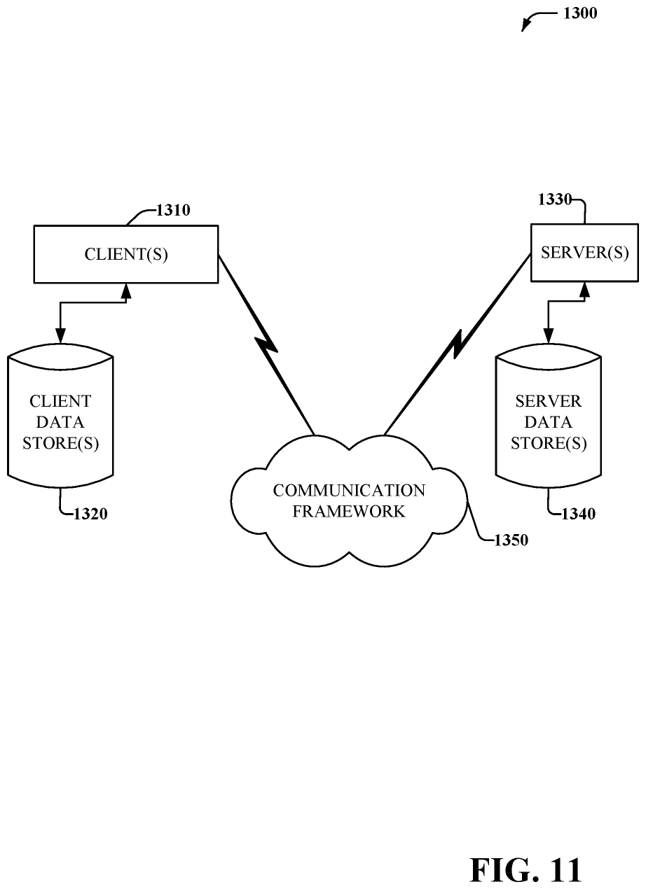

FIG. 11 is a schematic block diagram of a sample computing environment 1100 with which the disclosed subject matter can interact. The sample computing environment 1100 includes one or more client(s) 1110. The client(s) 1110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects of various embodiments described herein are presented in the following clauses.

1. A system, comprising: a processor that executes computer-executable components stored in a non-transitory computer-readable memory, the computer-executable components comprising: a drive mode component receives a sport mode level; a route determination component receives a target location data and determines a first route based on target location data and the sport mode level; an energy management component that determines a first energy level required to use the sport mode on the first route; and a user interface component that displays the first route and an indication that the sport mode is available to use based on the first energy level.

2. The system of any preceding clause, wherein the computer executable components further comprise: a monitoring component that monitors a set of vehicle measurements to determine an adjustment to a rolling resistance value.

3. The system of any preceding clause, wherein the computer executable components further comprise: a rolling resistance control component that adjusts a rolling resistance value based a set of vehicle measurements received.

4. The system of any preceding clause, wherein the set of vehicle measurements comprises a wheel angle measurement, a shock usage measurement, and a tire pressure measurement.

5. The system of any preceding clause, wherein the route determination component further determines a second route if the sport mode is not available to use on the first route based on the first energy level.

6. The system of any preceding clause, wherein the user interface component displays an option to adjust the sport mode if the sport mode is not available to use on the first route based on the first energy level.

7. The system of any preceding clause, wherein the computer executable components further comprise: a monitoring component that monitors a wheel angle usage and a tire pressure measurement; a rolling resistance control component that adjusts a rolling resistance value if the wheel angle usage and the tire pressure measurement is above an energy consumption threshold.

8. The system of any preceding clause, wherein the route determination component further determines a second route if the first energy level is above an energy consumption threshold.

9. The system of any preceding clause 8, wherein the user interface component displays an option to adjust the sport mode if the first energy level is above an energy consumption threshold.

10. The system of any preceding clause, wherein the computer executable components further comprise: a rolling resistance control component that adjusts a rolling resistance value based a wheel angle measurement, a shock usage measurement, a tire pressure measurement and an energy consumption measurement.

In various cases, any suitable combination or combinations of clauses 1-10 can be implemented.

11. A computer-implemented method, comprising: receiving, by a system comprising a processor, a sport mode level; receiving, by the system, a target location data and determining a first route based on target location data and the sport mode level; determining, by the system, a first energy level required to use the sport mode on the first route; and displaying, by the system, the first route and an indication that the sport mode is available to use based on the first energy level.

12. The computer-implemented method of any preceding clause, further comprising: monitoring, by the system, a set of vehicle measurements to determine an adjustment to a rolling resistance value.

13. The computer-implemented method of any preceding clause, further comprising: adjusting, by the system, a rolling resistance value based a set of vehicle measurements received.

14. The computer-implemented method of any preceding clause, wherein the set of vehicle measurements comprises a wheel angle measurement, a shock usage measurement, and a tire pressure measurement.

15. The computer-implemented method of any preceding clause, further comprising:

determining, by the system, a second route if the sport mode is not available to use on the first route based on the first energy level.

16. The computer-implemented method of any preceding clause, further comprising:
displaying, by the system, an option to adjust the sport mode if the sport mode is not available to use on the first route based on the first energy level.

In various cases, any suitable combination or combinations of clauses 11-16 can be implemented.

17. A non-transitory machine-readable medium, comprising executable instructions that, when executed by a processor, facilitate performance of operations, comprising: receiving a sport mode level and a target location data;
determining a first route based on target location data and the sport mode level and determining a first energy level required to use the sport mode on the first route; and
displaying the first route and an indication that the sport mode is available to use based on the first energy level.

18. The non-transitory machine-readable medium of any preceding clause, further comprising: monitoring a set of vehicle measurements to determine an adjustment to a rolling resistance value.

19. The non-transitory machine-readable medium of any preceding clause, further comprising: adjusting a rolling resistance value based a set of vehicle measurements received.

20. The non-transitory machine-readable medium of any preceding clause, further comprising: determining a second route if the sport mode is not available to use on the first route based on the first energy level.

In various cases, any suitable combination or combinations of clauses 17-20 can be implemented.

In various cases, any suitable combination or combinations of clauses 1-20 can be implemented.

What is claimed is:

1. A system, comprising:
a processor that executes computer-executable components stored in a non-transitory computer-readable memory, the computer-executable components comprising:
a drive mode component receives a sport mode level;
a route determination component receives a target location data and determines a first route based on target location data and the sport mode level;
an energy management component that determines a first energy level required to use the sport mode on the first route; and
a user interface component that displays the first route and an indication that the sport mode is available to use based on the first energy level.

2. The system of claim 1, wherein the computer executable components further comprise:
a monitoring component that monitors a set of vehicle measurements to determine an adjustment to a rolling resistance value.

3. The system of claim 2, wherein the computer executable components further comprise:
a rolling resistance control component that adjusts a rolling resistance value based a set of vehicle measurements received.

4. The system of claim 3, wherein the set of vehicle measurements comprises a wheel angle measurement, a shock usage measurement, and a tire pressure measurement.

5. The system of claim 1, wherein the route determination component further determines a second route if the sport mode is not available to use on the first route based on the first energy level.

6. The system of claim 5, wherein the user interface component displays an option to adjust the sport mode if the sport mode is not available to use on the first route based on the first energy level.

7. The system of claim 1, wherein the computer executable components further comprise:
a monitoring component that monitors a wheel angle usage and a tire pressure measurement;
a rolling resistance control component that adjusts a rolling resistance value if the wheel angle usage and the tire pressure measurement is above an energy consumption threshold.

8. The system of claim 1, wherein the route determination component further determines a second route if the first energy level is above an energy consumption threshold.

9. The system of claim 8, wherein the user interface component displays an option to adjust the sport mode if the first energy level is above an energy consumption threshold.

10. The system of claim 1, wherein the computer executable components further comprise:
a rolling resistance control component that adjusts a rolling resistance value based a wheel angle measurement, a shock usage measurement, a tire pressure measurement and an energy consumption measurement.

11. A computer-implemented method, comprising:
receiving, by a system comprising a processor, a sport mode level;
receiving, by the system, a target location data and determining a first route based on target location data and the sport mode level;
determining, by the system, a first energy level required to use the sport mode on the first route; and
displaying, by the system, the first route and an indication that the sport mode is available to use based on the first energy level.

12. The computer-implemented method of claim 11, further comprising:
monitoring, by the system, a set of vehicle measurements to determine an adjustment to a rolling resistance value.

13. The computer-implemented method of claim 12, further comprising:
adjusting, by the system, a rolling resistance value based a set of vehicle measurements received.

14. The computer-implemented method of claim 13, wherein the set of vehicle measurements comprises a wheel angle measurement, a shock usage measurement, and a tire pressure measurement.

15. The computer-implemented method of claim 11, further comprising:
determining, by the system, a second route if the sport mode is not available to use on the first route based on the first energy level.

16. The computer-implemented method of claim 15, further comprising:
displaying, by the system, an option to adjust the sport mode if the sport mode is not available to use on the first route based on the first energy level.

17. A non-transitory machine-readable medium, comprising executable instructions that, when executed by a processor, facilitate performance of operations, comprising:
receiving a sport mode level and a target location data;
determining a first route based on target location data and the sport mode level and determining a first energy level required to use the sport mode on the first route; and
displaying the first route and an indication that the sport mode is available to use based on the first energy level.

18. The non-transitory machine-readable medium of claim 17, further comprising:
monitoring a set of vehicle measurements to determine an adjustment to a rolling resistance value.

19. The non-transitory machine-readable medium of claim 18, further comprising:
adjusting a rolling resistance value based a set of vehicle measurements received.

20. The non-transitory machine-readable medium of claim 17, further comprising:
determining a second route if the sport mode is not available to use on the first route based on the first energy level.
